(19) United States
(12) Patent Application Publication
(10) Pub. No.: US 2022/0339864 A1
(43) Pub. Date: Oct. 27, 2022

(54) METHOD FOR PRODUCING A COMPOSITE BODY AND COMPOSITE BODY

(71) Applicant: Oechsler AG, Ansbach (DE)

(72) Inventors: Joachim STURM, Sachsen bei Ansbach (DE); Frank SCHINZEL, Fuerth (DE)

(73) Assignee: Oechsler AG, Ansbach (DE)

(21) Appl. No.: 17/728,536

(22) Filed: Apr. 25, 2022

(30) Foreign Application Priority Data
Apr. 26, 2021 (DE) 10 2021 110 627.3

(51) Int. Cl. B29C 64/188; B29C 64/153; B29C 64/364; B29C 65/48; B33Y 40/20

(52) U.S. Cl. CPC B29C 64/188; B29C 64/153; B29C 64/364; B29C 65/4895; B33Y 40/20; B29K 2995/0073; B33Y 10/00

(57) ABSTRACT

A method for producing a composite body from at least two partial bodies, at least one of the partial bodies being produced in an additive manufacturing process, includes exposing the at least two partial bodies to a solvent atmosphere, so that one surface of the partial body is smoothed. The at least two partial bodies are placed in the chamber in such a way that they touch at least one joining surface and that the solvent atmosphere creates a material connection between the at least two partial bodies on the at least one joining surface.

### FIELD

The present invention relates to a method for producing a composite body from at least two partial bodies, wherein at least one of the partial bodies is produced in an additive manufacturing process, wherein the at least two partial bodies are exposed to a solvent atmosphere in a chamber, so that one surface of the partial bodies is smoothed. The invention also relates to a composite body made in accordance with the method.

### BACKGROUND

Various additive manufacturing or 3D printing methods are known. A printing device generally builds up the bodies to be produced. In most cases, a targeted solidification of an initially liquid or loose material is used for this purpose. Some of the common advantages of these methods are a simple decentralized production and the short time between a design and the manufactured product. This is particularly beneficial for the production of prototypes, for example.

In many additive manufacturing processes, it is necessary to post-treat the manufactured body. Support structures have to be removed, for example, or a very rough surface of the body caused by the manufacturing process has to be smoothed. For smoothening purposes, it is known, for example, to expose bodies from an additive manufacturing process to a corrosive atmosphere or a solvent atmosphere in a corresponding chamber. The efficiency of this process can be increased if a plurality of manufactured bodies is treated with an appropriate atmosphere at the same time.

Such a method is known, for example, from DE 10 2015 115 821 A1, which teaches in particular to treat a plurality of bodies simultaneously and to arrange the bodies at a distance from one another and from the inner walls of the chamber.

Additive manufacturing processes generally have the disadvantage that, due to a limited volume in the printing device, only bodies with a limited size can be produced. In order to avoid this disadvantage, it is known to subdivide larger bodies into smaller partial bodies that are printed individually and joined together later. In the case of partial bodies with filigree structures, however, the joining step is usually very complex and therefore time-consuming and costly.

### SUMMARY

It is therefore the object of the present invention to provide a method for producing a composite body and a composite body in which an additional step of joining the partial bodies can be left out.

The object is achieved by a method and a composite body with the features of the independent patent claims.

In the method for producing a composite body from at least two partial bodies produced in an additive manufacturing process, the at least two partial bodies are exposed to a solvent atmosphere in a chamber, so that one surface of the partial bodies is smoothed. According to the invention, it is proposed that the at least two partial bodies are placed in the chamber in such a way that they touch at least one joining surface and that the solvent atmosphere creates a material connection between the at least two partial bodies on the at least one joining surface.

The solvent atmosphere at least partially dissolves chemical bonds on the surface of the partial bodies. As a result, the molecules on the surface can rearrange themselves or are removed, which reduces the roughness of the surface. Furthermore, a material connection is thus created between the partial bodies at the joining surface. A separate step of joining the partial bodies thus becomes unnecessary. A partial body produced in an additive manufacturing process can be joined in this way, for example, to at least one partial body produced in an injection molding process and/or to at least one other partial body produced in an additive manufacturing process.

It is conceivable that the partial bodies are first placed in the chamber and then the solvent atmosphere is introduced into the chamber. On the other hand, it is conceivable that the partial bodies are introduced into a chamber provided with a solvent atmosphere. The solvent atmosphere is, for example, an aerosol, in particular a mist, i.e., a mixture of an atomized solvent and air, for example. On the other hand, it is conceivable to use solvent vapor in pure form or mixed with air, for example, as a gas mixture.

To accelerate the reaction, the chamber can be heated to a temperature of 25 to 100° C., for example. The method does, however, preferably take place at room temperature. The solvent atmosphere can be produced, for example, by spraying a solvent or by atomizing the solvent, for example by means of an ultrasonic atomizer. A targeted evaporation of the solvent is conceivable as well.

Because of the health hazard and potential explosion hazard, the chamber is preferably hermetically sealed during the presence of the solvent atmosphere. It is conceivable that the solvent atmosphere is evacuated before the chamber is opened at the end of the process.

It is advantageous if the at least two partial bodies are joined together on the at least one joining surface in a positive-fitting manner. This improves the subsequent cohesion of the at least two partial bodies. In addition, it is easier to produce a homogeneous composite body in this way. The positive fit can result, for example, from the fact that the joining surface between the partial bodies is formed by boundary surfaces of unit cells of a lattice structure of the partial bodies.

If the partial bodies each have a lattice structure, the partial bodies touch one another, for example, along lattice bars of the lattice structure. These lattice bars can, for example, form the edges of the unit cells of the lattice structure. The positive fit described here can relate to the parallel alignment of the lattice bars. A plurality of joining surfaces can consist of a plurality of lattice bars aligned in parallel and in pairs.

It is particularly advantageous if at least one of the partial bodies is produced with a powder-based 3D printing process. In contrast to other 3D printing methods, this method makes it possible to print the partial bodies without an additional support structure. A subsequent removal of a support structure is therefore not necessary.

In powder-based 3D printing processes, the bodies to be printed are built up layer by layer from a powder. This usually starts with the bottom layer with a binder being applied to a layer of powder, for example, which hardens and binds the powder in a targeted manner. The next layer of powder is then applied and treated with the binder as well. It is also conceivable to harden and bind the powder in a selective heating process.

In this context, the printed body is always in a loose powder environment that protects and supports the body. After this process, the body generally has a rough surface which, however, is smoothed in the solvent atmosphere within the context of the method according to the invention. Naturally, both or all of the at least two partial bodies can be produced in the powder-based 3D printing process.

It is also advantageous if at least one of the two partial bodies is produced with a lattice structure. Due to the lattice structure, a large volume can be filled with little material. The elasticity of the partial body can also be precisely controlled by the lattice structure. This is particularly advantageous for padding. Ideally, the joining surface of the partial bodies is no longer recognizable in the composite body, at least on the basis of an inhomogeneous elasticity. Both or all of the at least two partial bodies can be produced with a lattice structure. In this case, the lattice structure of the partial bodies is preferably the same.

It is advantageous if the at least two partial bodies are placed in the solvent atmosphere in such a way that they touch at a plurality of joining surfaces, the plurality of joining surfaces corresponding to a plurality of boundary surfaces of the unit cells of the structure of the partial bodies. This ensures that the structures of the partial bodies complement each other to form a structure of the composite body that is as uniform as possible. This improves the homogeneity, particularly with regard to the elasticity of the body. The structure described can be any structure that is made up of a large number of identical unit cells, i.e., the smallest space-filling components. In particular, the structure is a lattice structure. The boundary surfaces separate the individual unit cells from one another. They do not necessarily have to be filled with material. The lattice bars joined to one another may form the edges of a boundary surface as well, for example.

Preferably, this aspect is already taken into account in the design or in the subdivision of the body into partial bodies before the production of the partial bodies. The lattice structure of the body is separated, for example, into the partial bodies along the boundary surfaces of the unit cells of the structure (so-called “cell-conformed cutting”).

It is also advantageous if the partial bodies are joined together in such a way that a uniform lattice structure of the composite body is formed. As already described, this can improve the homogeneity, in particular with regard to the elasticity of the body.

Especially when the body is padding or part of a padding element with which a subsequent user has direct contact, inhomogeneities in the elasticity can be uncomfortable for the user and thus disadvantageous for the economic success of the body. This is to be avoided.

It is advantageous if the at least two partial bodies are produced with at least one connecting element, in particular a connecting joint. In addition, or as an alternative, it is advantageous if the at least two partial bodies are folded together via the connecting element so that the two partial bodies rest against one another with their corresponding joining surfaces. This ensures an error-free assembly of the partial bodies along the at least one joining surface. In particular, the freedom of movement of the partial bodies relative to one another can be restricted by one or more joints in such a way that the partial bodies can only be assembled in one way to form the body. It is conceivable to “fold” the partial bodies to form the body. The connecting joint or the connecting joints can also be produced by the additive manufacturing process. If necessary, the joint or joints can be removed again after the partial bodies have been joined to form the body.

In the case of a particularly wide body that exceeds the width of the printing device, it is conceivable to subdivide the body into at least two partial bodies that can be printed one above the other and that are possibly joined to the described connecting joint or joints. In particular, two connecting joints can be provided.

Furthermore, it is advantageous if the at least two partial bodies are produced from a thermoplastic, in particular polyamide 12 (PA12) and/or an elastomer, in particular TPU. On the one hand, this makes it easier to produce the partial bodies. On the other hand, after the parts have been joined together, this results in an elastically deformable but dimensionally stable body, for example, which can be used in particular as padding.

Examples of elastomers are vulcanizates of natural or silicone rubber. The abbreviation TPU stands for thermoplastic polyurethane. Polyurethanes are plastics or synthetic resins that result from a polyaddition reaction of dialcohols or polyols with polyisocyanates. Padding or thermal insulation materials in particular can advantageously be produced from foamed TPU. The thermoplastic properties are particularly advantageous during the manufacturing of products from these materials.

There are particular advantages when the solvent atmosphere contains chloroform, tetrahydrofuran, dimethylformamide, dimethylacetamide, N-methylpyrrolidone, dimethyl sulfoxide, hexafluoroisopropanol, pyridine and/or benzyl alcohol. These solvents are capable of dissolving TPU in particular and are therefore suitable for smoothing the surface of the partial bodies in an atmosphere and for establishing a positive connection between the partial bodies. It is conceivable to use a mixture of different solvents in the solvent atmosphere. As already described, an aerosol and/or a vapor can be produced from these solvents to create the solvent atmosphere.

The composite body according to the invention is composed of at least two partial bodies with at least one of the partial bodies being produced in an additive manufacturing process. It is characterized in that it is manufactured according to a method as described above. As already described, the body has the advantage that the partial bodies are already joined together while the surface of the partial bodies is being smoothed and thus eliminating an additional work step of joining them together during the production of the body. In addition, the body may have a size that exceeds the printing range of a printing device for an additive manufacturing process. It is conceivable that the body is composed of a large number of partial bodies.

The body has a lattice structure, for example, with the lattice structure preferably being homogeneous across the entire extent of the body. Motifs of the lattice structure are repeated at regular intervals, for example. The body is made, for example, from an elastomer and in particular from TPU. The body is designed in particular as padding or part of a padding element with a homogeneous elasticity.

### BRIEF DESCRIPTION OF DRAWING FIGURES

Further advantages of the invention are described in the following embodiments. In the drawings:

FIG. 1 is a two-dimensional diagram of the partial bodies before they are joined,

FIG. 2 is a two-dimensional diagram of the production of the body according to the method according to the invention,

FIG. 3 is a three-dimensional diagram of the partial bodies before they are put together, and

FIG. 4 is a three-dimensional diagram of the composite body.

### DETAILED DESCRIPTION

In the following description of the figures, the same reference signs are used for features that are identical and/or at least comparable in the various figures. The individual features, their design and/or mode of action are generally explained in detail when they are mentioned the first time. If individual features are not explained in detail again, their design and/or mode of action corresponds to the design or mode of action of the features already described that have the same effect or the same name.

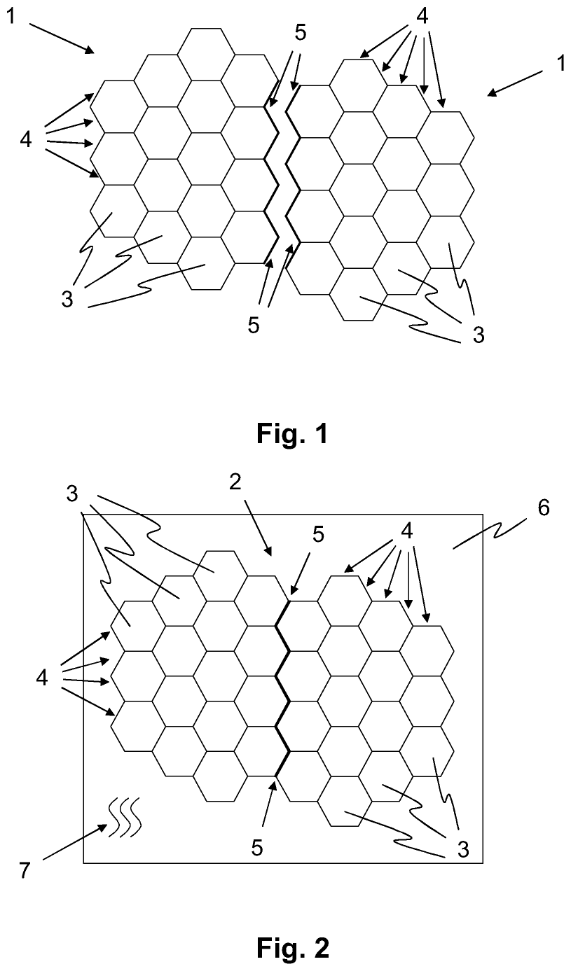

In a two-dimensional diagram, FIG. 1 shows two partial bodies 1 which are joined together to form a body 2 according to the invention (see FIG. 2 and FIG. 4) in the method according to the invention. The two-dimensional representation serves to illustrate the principle. As a rule, the body 2 will have a three-dimensional shape. As shown in FIG. 1, the two partial bodies 1 have a matching lattice structure. In this example, the lattice structures have hexagonal unit cells 3 from which the lattice structure is built. Less symmetrical unit cells can be used as well. A combination of different lattice motifs as the smallest unit of the lattice is conceivable as well.

The partial bodies 1 are delimited in such a way that only complete unit cells 3 are present in the lattice structure. In other words, the partial bodies 1 are delimited by the boundary surfaces 4 of the unit cells 3. Likewise, a joining surface 5 or a plurality of joining surfaces 5, on which the partial bodies 1 touch during the method (see also FIG. 2), is formed by a plurality of the boundary surfaces 4 of the unit cells 3.

FIG. 2 shows the method according to the invention for producing the composite body 2 in a two-dimensional diagram. The at least two partial bodies 1 produced in an additive manufacturing process are placed in a chamber 6 in such a way that they touch at least one joining surface 5. A solvent atmosphere 7 is present in the chamber 6. On the one hand, the solvent atmosphere 7 smooths one surface of the partial bodies 1. On the other hand, a cohesive connection is formed on the at least one joining surface 5 between the partial bodies 1, as a result of which the composite body 2 is produced. Due to the shape of the partial bodies 1 aligned by the boundary surfaces 4 of the unit cells 3, the partial bodies 1 can be joined in a positive-fitting manner.

In particular, the composite body 2 has a continuous and homogeneous lattice structure. Ideally, the at least one joining surface 5 is no longer recognizable after the end of the method. The solvent atmosphere 7 can be produced in the manners already described. For safety purposes, the chamber 6 is hermetically sealed, for example, during the presence of the solvent atmosphere 7. The partial bodies 1 can, for example, be placed in the chamber 6 on supports (not shown) or hung up on hooks (not shown).

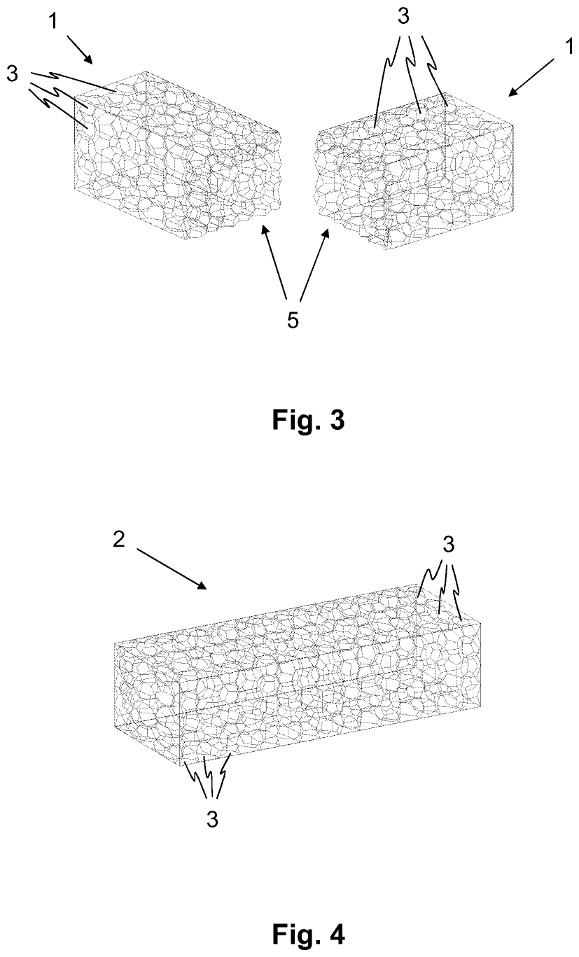

FIG. 3 and FIG. 4 show a three-dimensional model of the partial body 1 and the composite body 2. The body 2 has a cuboid shape with a lengthwise extent of the body 2 exceeding, for example, the width of a corresponding 3D printing device. For this reason, the body 2 is divided into two partial bodies 1 prior to the production which are each produced in a corresponding 3D printing device.

When the body 2 is separated into the partial bodies 1, care is taken to ensure that the unit cells 3 are retained during the separation. This ensures that the partial bodies 1 can later be assembled in a positive-fitting manner. The partial bodies 1 and the body 2 have a three-dimensional lattice structure. The elasticity of the body 2 can be specifically influenced by these lattice structures. A material-saving production is possible. The composite body 2 can be used as padding, for example. As shown in FIG. 4, the partial bodies 1 of the composite body 2 can no longer be seen individually.

The present invention is not limited to the embodiments that are illustrated and described. Modifications within the scope of the claims are just as possible as a combination of features even if they are shown and described in different embodiments.

### LIST OF REFERENCE SIGNS

1 Partial body
2 Body
3 Unit cell
4 Boundary surface
5 Joining surface
6 Chamber
7 Solvent atmosphere

1. Method for producing a composite body from at least two partial bodies, wherein at least one of the partial bodies is produced in an additive manufacturing process, the method comprising:
placing the at least two partial bodies in a chamber in such a way that they touch at least one joining surface, and
exposing the at least two partial bodies to a solvent atmosphere such that one surface of the partial bodies is smoothed, wherein the solvent atmosphere leads to the creation of a cohesive connection between the at least two partial bodies on the at least one joining surface.

2. Method according to claim 1, wherein the at least two partial bodies are joined together in a positive-fitting manner on the at least one joining surface.

3. Method according to claim 1, wherein at least one of the partial bodies is produced in a powder-based 3D printing process.

4. Method according to claim 1, wherein at least one of the partial bodies is produced with a lattice structure.

5. Method according to claim 1, wherein the at least two partial bodies are placed in the solvent atmosphere in such a way that they touch at a plurality of joining surfaces, the plurality of joining surfaces corresponding to a plurality of boundary surfaces of the unit cells of the structure of the partial bodies.

6. Method according to claim 1, wherein the partial bodies are joined in such a way that a uniform lattice structure of the assembled body is formed.

7. Method according to claim 1, wherein the at least two partial bodies are produced with at least one connecting element, in particular a connecting joint, and/or are folded together via the connecting element, so that the two partial bodies rest against one another with their corresponding joining surfaces.

8. Method according to claim 1, wherein the at least two partial bodies are produced from a thermoplastic, in particular polyamide 12 and/or an elastomer, in particular TPU.

9. Method according to claim 1, wherein the solvent atmosphere contains chloroform, tetrahydrofuran, dimethylformamide, dimethylacetamide, N-methylpyrrolidone, dimethyl sulphoxide, hexafluoroisopropanol, pyridine and/or benzyl alcohol.

10. Composite body composed of at least two partial bodies, with at least one of the partial bodies being produced in an additive manufacturing process, wherein the body is produced according to a method of claim 1.
